(19) United States
(12) Patent Application Publication
(10) Pub. No.: US 2009/0070669 A1
(43) Pub. Date: Mar. 12, 2009

(54) IMAGE MANAGEMENT APPARATUS AND CONTROL METHOD THEREFOR

(75) Inventor: Yuichiro Hirota, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/205,073

(22) Filed: Sep. 5, 2008

(30) Foreign Application Priority Data
Sep. 7, 2007 (JP) 2007-233383

(51) Int. Cl. G06F 9/00

(52) U.S. Cl. 715/700

(57) ABSTRACT

An image management apparatus for managing a plurality of images is configured to manage image files so that an image used as a search key, which is of importance to a user, can be displayed with priority according to a high-visibility layout. A plurality of images are assigned priority levels. The images are arranged at positions corresponding to pieces of time information of the images and the assigned priority levels, and are displayed in a display area having a time axis. The priority levels are assigned by classifying the images according to differences between the pieces of time information.

### BACKGROUND OF THE INVENTION

1. Field of the Invention

The present invention relates to an image file management technique suitable for browsing and searching through a plurality of image files on a computer.

2. Description of the Related Art

In the related art, a large number of image files captured using digital cameras or the like are managed on computers. Thumbnail images of individual image files are chronologically arranged according to time information and are displayed on a screen. U.S. Patent Publication No. 2006/0156246 discloses a technique in which image files are classified into groups according to time information and in which thumbnails of image files are chronologically arranged for each group and displayed on a screen. In the related art, however, if times assigned to image files are close to each other or if there are a large number of image files, thumbnail images of such image files may overlap each other or may be small in size, resulting in difficulty in viewing the thumbnail images. This makes it difficult for a user to search for a desired file. A large amount of time would be required to display thumbnail images of a large number of image files due to insufficient computer resources.

### SUMMARY OF THE INVENTION

The present invention provides the capability of displaying with priority an image used as a search key, which is of importance to a user, to ensure that images can be displayed according to a high-visibility layout.

In an aspect, the present invention provides an image management apparatus that manages a plurality of images. The image management apparatus includes an assigning unit configured to assign priority levels to the images, and a drawing unit configured to draw the images in a display area having a time axis according to a layout that is based on the assigned priority levels and pieces of time information of the images, wherein the assigning unit assigns priority levels to the images so that a difference between a piece of time information of an n-th priority level image and a piece of time information of an (n+1)-th priority level image is greater than a difference between the piece of time information of the n-th priority level image and a piece of time information of an (n+2)-th priority level image.

In another aspect, the present invention provides an image management apparatus that manages a plurality of images. The image management apparatus includes an assigning unit configured to assign priority levels to the plurality of images, and a drawing unit configured to draw the images in a display area having a time axis according to a layout that is based on the assigned priority levels and pieces of time information of the images, wherein the assigning unit classifies the images into hierarchical groups on the basis of differences between the pieces of time information of the images, and assigns priority levels to the images on the basis of the number of images belonging to each of the groups and measurements among the differences between the pieces of time information within the individual groups.

In another aspect, the present invention provides a control method for an image management apparatus that manages a plurality of images. The control method includes: assigning priority levels to the images, and drawing the images in a display area having a time axis according to a layout that is based on the assigned priority levels and pieces of time information of the images, wherein in the assigning, priority levels are assigned to the images so that a difference between a piece of time information of an n-th priority level image and a piece of time information of an (n+1)-th priority level image is greater than a difference between the piece of time information of the n-th priority level image and a piece of time information of an (n+2)-th priority level image.

In another aspect, the present invention provides a control method for an image management apparatus that manages a plurality of images. The control method includes assigning priority levels to the plurality of images, and drawing the images within a display area having a time axis according to a layout that is based on the assigned priority levels and pieces of time information of the images, wherein in the assigning, the images are classified into hierarchical groups according to differences between the pieces of time information of the images, and priority levels are assigned to the images on the basis of the number of images belonging to each of the groups and measurements among the differences between the pieces of time information within the individual groups.

In another aspect, the present invention provides a computer-readable storage medium on which is stored a computer program for causing a computer to implement an image management apparatus that manages a plurality of images, and execute a method of controlling. The program includes: assigning priority levels to the images, and drawing the images in a display area having a time axis according to a layout that is based on the assigned priority levels and pieces of time information of the images, wherein in the assigning, priority levels are assigned to the images so that a difference between a piece of time information of an n-th priority level image and a piece of time information of an (n+1)-th priority level image is greater than a difference between the piece of time information of the n-th priority level image and a piece of time information of an (n+2)-th priority level image.

In another aspect, the present invention provides a computer-readable storage medium on which is stored a computer program for causing a computer to implement an image management apparatus that manages a plurality of images, and execute a method of controlling. The program includes: assigning priority levels to the plurality of images, and drawing the images within a display area having a time axis according to a layout that is based on the assigned priority levels and pieces of time information of the images, wherein in the assigning, the images are classified into hierarchical groups on the basis of differences between the pieces of time information of the images, and priority levels are assigned to the images on the basis of the number of images belonging to each of the groups and measurements among the differences between the pieces of time information within the individual groups.

Further features of the present invention will become apparent from the following description of exemplary embodiments with reference to the attached drawing.

### BRIEF DESCRIPTION OF THE DRAWINGS

FIG. 1 is a block diagram illustrating an example of a structure of an image file management system according to the present invention.

FIG. 2 is a block diagram illustrating an example of a structure of an information processing apparatus according to the present invention.

FIG. 3 is a diagram illustrating an example of a thumbnail list view according to the present invention.

FIG. 4 is a flowchart illustrating an example of a procedure of a thumbnail drawing process according to the present invention.

FIG. 5 is a flowchart illustrating an example of an initialization procedure of an image prioritization process according to the present invention.

FIG. 6 is a flowchart illustrating an example of a procedure of an image clustering process according to the present invention.

FIG. 7 is a diagram illustrating an example of the correspondence between image files and shooting dates/times associated therewith according to the present invention.

FIG. 8 is a diagram illustrating an example of the plotting of image files on a time axis according to the present invention.

FIG. 9 is a diagram illustrating an example of the correspondence between clusters generated by clustering image files and shooting dates/times associated therewith according to the present invention.

FIG. 10 is a diagram illustrating an example of the plotting of clustered image files into a tree structure according to the present invention.

FIG. 11 is a flowchart illustrating an example of a procedure of an image prioritization process according to the present invention.

FIG. 12 is a flowchart illustrating an example of a procedure of a process for extracting a representative image from a cluster in the prioritization process according to the present invention.

FIG. 13 is a diagram illustrating an example of image prioritization according to the present invention.

FIG. 14 is a flowchart illustrating an example of a process for selecting an image to be displayed according to the present invention.

### DESCRIPTION OF THE EMBODIMENTS

An exemplary embodiment of the present invention will be described in detail hereinafter with reference to the accompanying drawings.

The following embodiment is merely an example of embodiments of the present invention, and may be modified or changed depending on a structure of an apparatus to which the present invention is applied or various conditions. The present invention is not to be limited to the following embodiment.

### Description of System Configuration

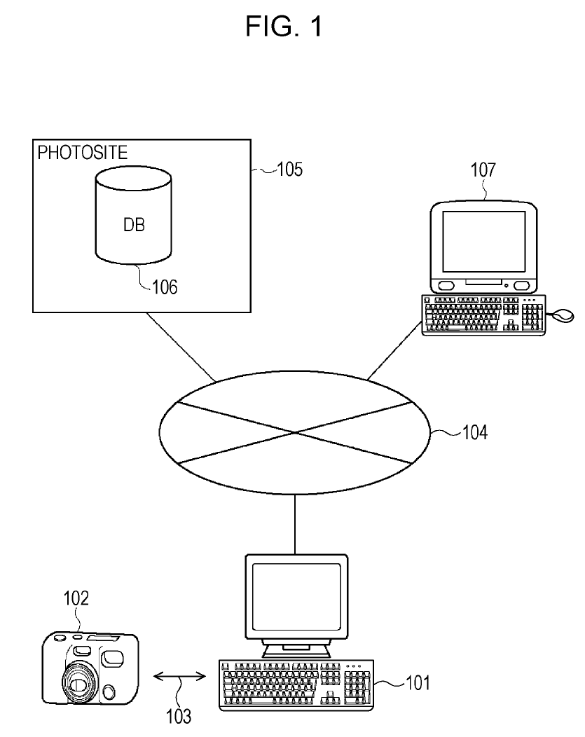

FIG. 1 is a schematic diagram illustrating an example of an image management system according to an embodiment of the present invention.

A personal computer (PC) 101 is a computer for personal use that can load image files into a memory and that can execute an application program for implementing an image file management function according to the present invention. The application program is hereinafter referred to as an “image file management program”.

An image input device 102 has functions for converting an optical image representing image information into an electrical signal, subjecting the electrical signal to predetermined image processing, adding information regarding a shooting date and time obtained from an internal clock to the electrical signal subjected to the image processing to produce an image file, storing the image file, and viewing the image file. The image input device 102 may be, for example, a digital still camera that can capture an image of a subject and that can store the captured image as a still image file. Alternatively, the image input device 102 may be any other device capable of generating an image file with shooting date and time information added thereto, such as a digital video camera or a scanner.

In the following description, it is assumed that each image file has shooting date and time information added thereto.

A data-transfer interface 103 is an interface configured to transfer image data input from the image input device 102 to the PC 101. The data-transfer interface 103 may be a wired communication interface such as a universal serial bus (USB) or IEEE (Institute of Electrical and Electronics Engineers) 1394 interface. Alternatively, the data-transfer interface 103 may be a wireless communication interface such as an Infrared Data Association (IrDA) or Bluetooth® interface.

The PC 101 can be connected to the image input device 102, as necessary, via the data-transfer interface 103 to receive an image file with shooting date and time information.

The PC 101 can also obtain image files from various resources present on the Internet 104, as well as from the image input device 102, according to necessity. A photosite 105 is a site having a database (DB) 106 that can store image files, and is designed to provide services for sharing the image files with a large number of users accessing the Internet 104. The PC 101 can download an image file from the photosite 105, as required.

The PC 101 can also obtain an image file using a communication medium such as email from another PC 107 accessing the Internet 104, such as a friend's PC, or an image file directly from a storage medium such as a flash memory without using a network.

In the present embodiment, the Internet 104 is used as a communication infrastructure, by way of example. In place of the Internet 104, a local area network (LAN) or a wide area network (WAN) may be used.

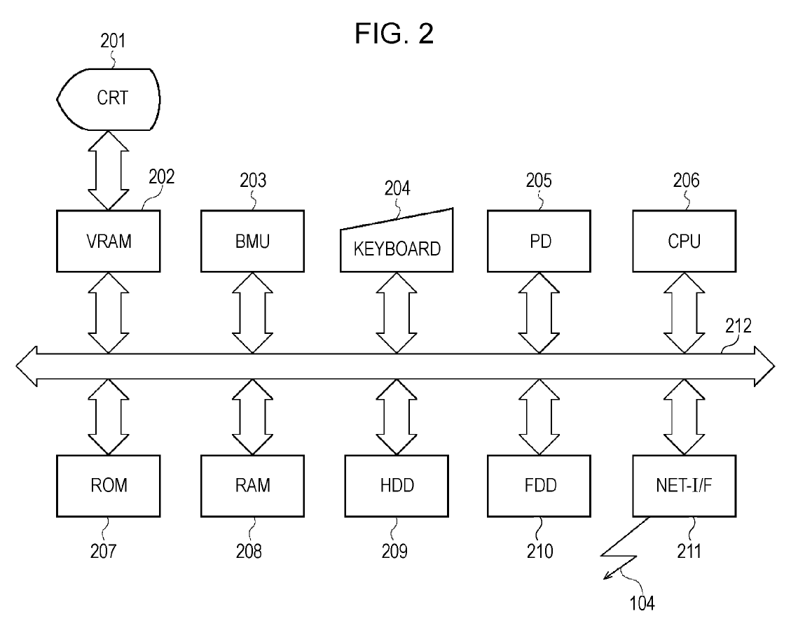

FIG. 2 is a block diagram illustrating a structure of the PC 101, which may be an information processing apparatus that can execute the image file management program of the present embodiment.

In FIG. 2, a cathode ray tube (CRT) display 201 has a display screen on which a currently edited object such as a document, a figure, or an image is displayed. Also displayed on the display screen is a rectangular display area in which drawing is performed by the image file management program of the present embodiment.

A video random access memory (VRAM) 202 stores image data to be displayed on the display screen of the CRT display 201. The image data generated in the VRAM 202 is transferred to the CRT display 201 according to a predetermined protocol, and an image based on the image data is displayed on the CRT display 201.

A bit move unit (BMU) 203 controls data transfer between memories (for example, between the VRAM 202 and another memory) or data transfer between a memory and an I/O device (for example, a network interface (Net-I/F) 211).

A keyboard 204 has various keys which can be operated by a user to give instructions to enter appropriate data such as character string data.

A pointing device (PD) 205 is used by the user to, for example, set drawing conditions for a thumbnail list view of the image file management program, which is displayed on the screen of the CRT display 201, or to select an image.

A central processing unit (CPU) 206 controls individual devices connected to the CPU 206 according to a control program stored in a read only memory (ROM) 207, a hard disk, or a floppy (registered trademark in Japan) disk.

The ROM 207 stores data such as various control programs.

A random access memory (RAM) 208 includes a work area of the CPU 206, a save area in which data is saved when a processing error occurs, and an area into which a control program is loaded.

A hard disk drive (HDD) 209 can store control programs executable by the information processing apparatus, and content. For example, the HDD 209 of the PC 101 stores an operating system (OS), a Web browser, image files, and the image file management program.

A floppy disk drive (FDD) 210 controls access to a floppy disk.

The network interface (Net-I/F) 211 establishes communications with other devices such as a PC and a printer via the Internet 104. A CPU bus 212 provides a communications path through which devices can communicate with one another. The CPU bus 212 includes an address bus, a data bus, and a control bus.

In the system or hardware configuration described above, the user who is allowed to access a large number of image files to be managed starts the image file management program stored in the hard disk 209 on the PC 101 to browse and search through the image files.

Functions implemented by the image file management program of the present embodiment will specifically be described.

### Thumbnail Drawing Process

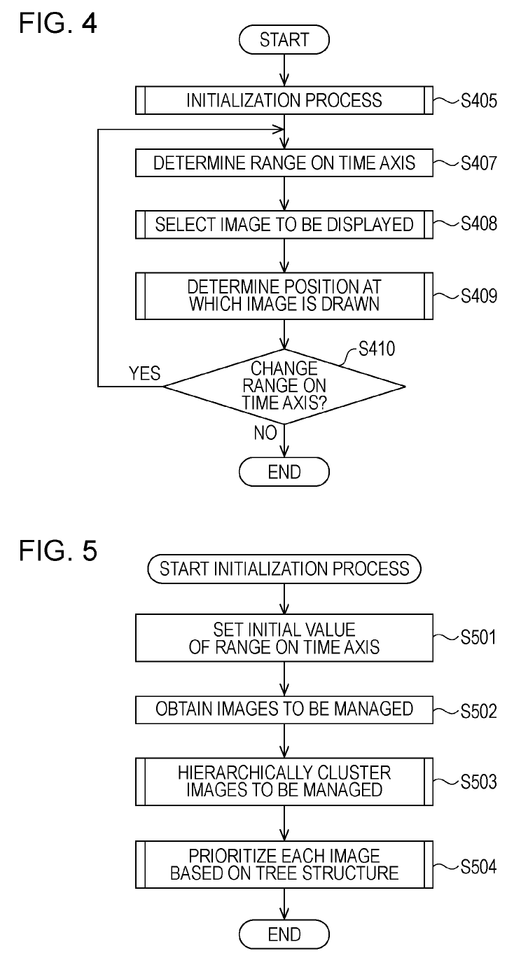

FIG. 4 is a flowchart illustrating a thumbnail drawing process implemented by the image file management program of the present embodiment.

The flow of FIG. 4 is initiated when the CPU 206 of the PC 101 starts the image file management program. First, in step S405, an initialization process is executed.

FIG. 5 is a flowchart illustrating the initialization process in step S405 in detail.

Referring to FIG. 5, in step S501, a time-axis setting process for setting an initial value of a time-axis range in which drawing is first performed by the image file management program is performed. The time-axis range may be set by prompting the user to enter a value through a user interface or may be set using a preset value stored in advance in the image file management program.

In step S502, the user assigns images to be managed to the image file management program. For example, in a Windows® OS, when the image file management program starts, a dialog appears prompting the user to specify a folder containing images, and the user specifies the path to the My Pictures folder.

In steps S503 and S504, the plurality of images to be managed, which are obtained in step S502, are assigned uniquely determined priority levels using a process described below. In step S503, the images to be managed are hierarchically clustered on the basis of their shooting dates and times to create a tree structure. In step S504, priority levels are actually assigned on the basis of the tree structure created in step S503.

The images to be managed and the priority levels assigned thereto, which are obtained in the initialization processing of step S405, are stored in the memory, and are repeatedly referred to during the execution of the image file management program. For increased efficiency of the initialization process, the above images and the assigned priority levels may be stored in an external storage device at the end of the image file management program so that they can be read next time the image file management program is started and can be reused if no changes are made to the images to be managed.

The above described is the initialization process executed when the image file management program starts.

Referring back to FIG. 4, in step S407, a time-axis range is set. The time-axis range initially has a value equal to the initial value set in step S501.

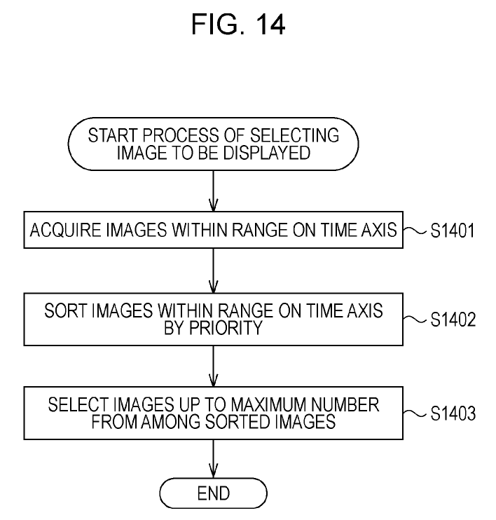

In step S408, images to be displayed are selected from among image files present within the time-axis range set in step S407 according to the priority levels stored in the memory so that the number of images to be displayed does not exceed a maximum number of images displayable on one screen. A process for selecting the images to be displayed will be described in detail below with reference to FIG. 14.

In step S409, the level of importance of each of the images to be displayed, which are selected in step S408, is calculated for a time zone according to the priority levels stored in the memory. For example, priority levels of images at the same position on an x axis representing a time axis are compared, and the images are assigned importance values so that the image having the highest priority level in that time zone is assigned the highest importance value. As a result, drawing positions at which the images are drawn within the rectangular display area defined by the time axis and an importance axis perpendicular to the time axis are determined in accordance with the shooting dates and times and the importance values assigned to the individual image files. Thus, image files having a high importance value in each time zone are displayed, and the user can quickly identify what type of image is presented in each time zone. Thumbnails of the images are drawn at the determined drawing positions. A process for determining the drawing positions will be described in detail below.

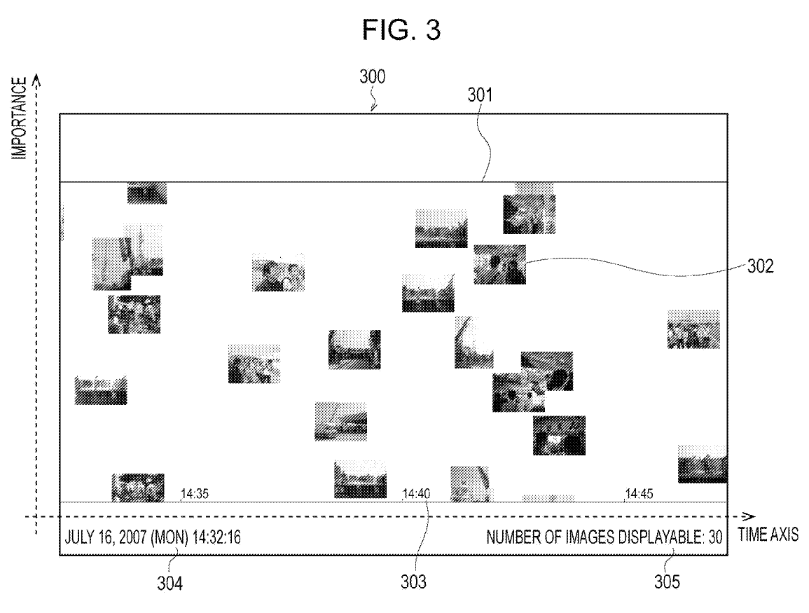

FIG. 3 illustrates an exemplary thumbnail list view 300 displayed using the position determining process in step S409.

Referring to FIG. 3, thumbnails 302 are displayed in a rectangular display area 301. The rectangular display area 301 has a time axis in the horizontal direction, and an importance axis in the vertical direction. Images to be displayed are drawn at designated positions in the rectangular display area 301 according to the assigned shooting dates and times and importance values.

The thumbnails 302 are drawn in the rectangular display area 301. As described above, the position of each thumbnail in the horizontal direction represents the date and time the associated image was captured, and the position of each thumbnail in the vertical direction represents the importance value of the associated image.

A scale 303 visually represents positions on the time axis in the horizontal direction of the rectangular display area 301. The user can update the range on the time axis in an interactive manner using the mouse or the like, and the unit intervals and unit (e.g., second, hour, day, month, etc.) of the scale 303 are also dynamically updated accordingly.

A time indicator 304 indicates the absolute position, on the time axis, of the left end of the rectangular display area 301. For example, in FIG. 3, the scale 303 is drawn so as to increase, such as 14:35, 14:40, and 14:45 from the left end, in steps of 5 minutes, and the time 14:35 represents 14:35 on Jul. 16, 2007.

A number-of-images indicator 305 indicates a maximum number of thumbnails displayable on one screen. If a greater number of images than the maximum number of displayable images are present within the time-axis range set by the user, only a number of images equal to the maximum number of displayable images are displayed according to the priority levels assigned to the images. The priority levels of the images are calculated on the basis of based the distribution of shooting dates/times, the details of which will be described below.

When the user wishes to change the time-axis range, the user inputs a desired time-axis range to the PC 101 while viewing the thumbnail list view 300 (step S410). The image file management program updates the thumbnail list view 300 according to the time-axis range desired by the user. The series of operations described above is iterated in an interactive manner by the user and the image file management program through the user interface to update the thumbnail list view 300 as desired by the user.

For example, the user finds an image acting as a key image at a time-axis position indicating “May 2004” within a time-axis range of “Jan. 1, 2004” to “Dec. 31, 2005”, and wishes to specifically browse through images around the key image. In this case, a time-axis range of “May 1, 2004” to “May 31, 2004” is re-designated as the time-axis range. Then, images captured in May 2004 are displayed on the thumbnail list view 300 along a timeline of shooting dates, and images that are not displayed on the initial thumbnail list view 300 are now displayed on the updated thumbnail list view 300. The user can find a desired image.

### Prioritization Process

A process for prioritizing the images to be managed, which is performed in steps S503 and S504 of FIG. 5, will now be described.

The prioritization process includes the process for hierarchically clustering the images to be managed (step S503 in FIG. 5), and the process for determining a priority level on the basis of the tree structure (step S504).

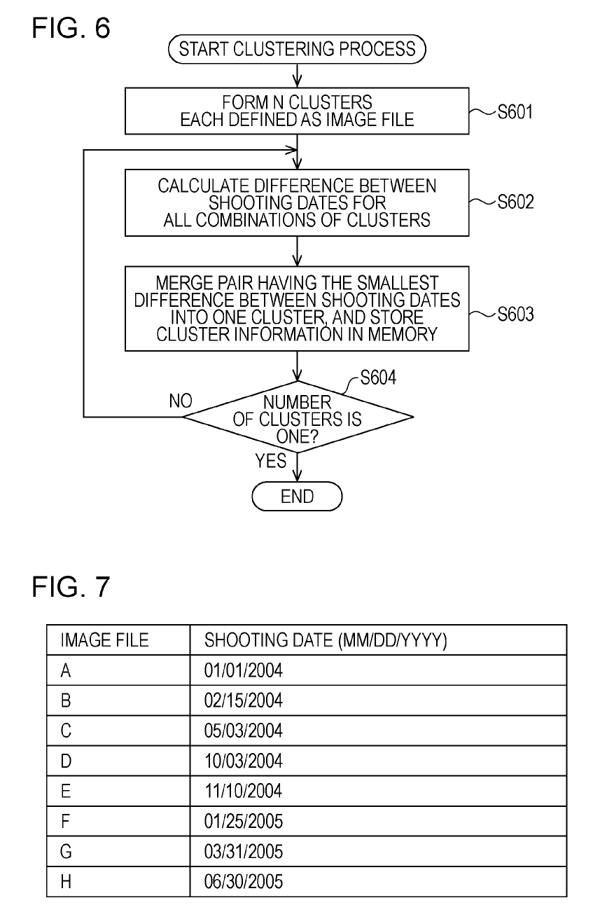

The process for hierarchically clustering N images to be managed, which is performed in step S503, will be described with reference to a flowchart in FIG. 6.

Referring to FIG. 6, first, in step S601, each image file is defined as a single cluster, and N clusters are defined.

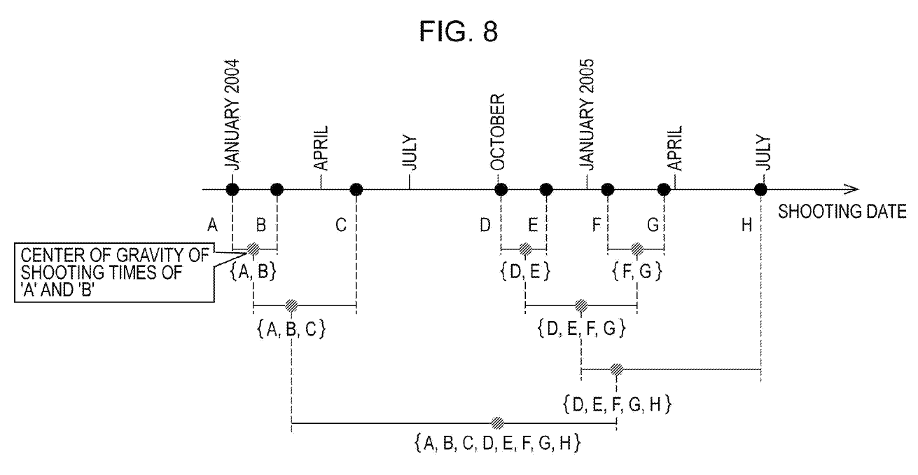

In step S602, dissimilarity is calculated for all combinations of cluster elements defined in step S601. Dissimilarity is defined as a linear distance, or Euclidean distance, between shooting dates/times of image files. The smaller the distance is, the more similar two elements are. FIG. 7 is a diagram illustrating the dissimilarity in a case where eight image files A to H having shooting date/time data are used as cluster elements. With regard to the date/time data, for the convenience of description, each image file has only a shooting date. In FIG. 8, the cluster elements are plotted on the time axis on the basis of the shooting dates thereof. As is apparent from FIGS. 7 and 8, the cluster element A has a smaller distance from the cluster element B than from the cluster element C, and the dissimilarity of the cluster element A to the cluster element B is therefore lower than that to the cluster element C.

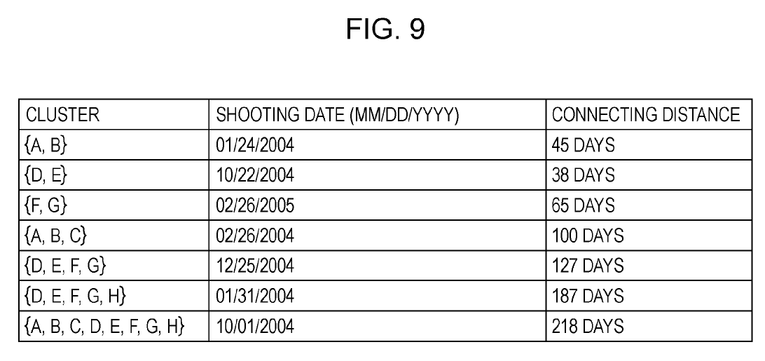

In step S603, dissimilarities determined in step S602 are compared, and the pair having the lowest dissimilarity are merged into one cluster. The shooting date/time of the new cluster produced by merging is determined by calculating a date/time at the center of gravity of each of the shooting dates/times of the original cluster elements. The shooting date/time set for each new cluster element is stored in the memory. FIG. 9 illustrates exemplary shooting dates of new cluster elements stored in the memory. As illustrated in FIG. 9, in each of the clusters, a plurality of sub-cluster elements and a shooting date are defined. For example, in the cluster {A, B, C} illustrated in FIG. 8, sub-clusters {A, B} and C, shooting date “Feb. 26, 2004”, and a distance of 100 days are defined.

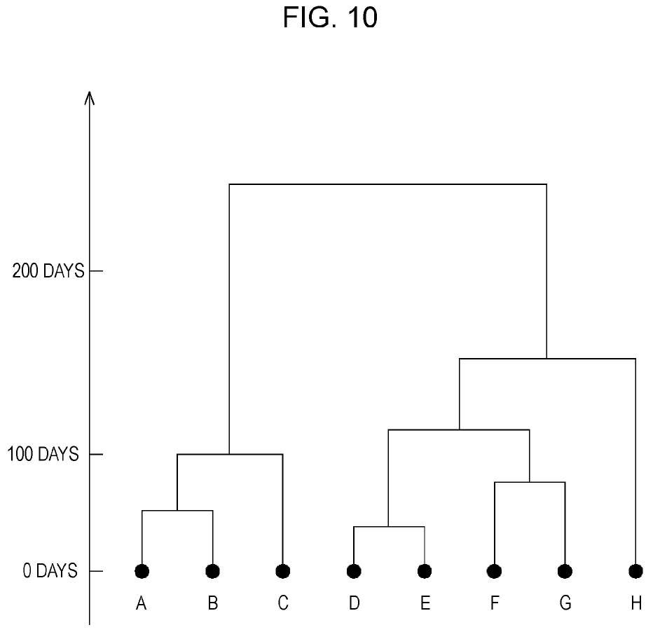

Also stored as a connecting distance in the memory is the distance between shooting dates of sub-cluster elements constituting each new cluster element. FIG. 10 illustrates an exemplary tree structure, where the connecting distance between sub-cluster elements is plotted on the ordinate. In FIG. 10, for example, the connecting distance of the cluster (A, B, C) is 100 days.

In step S604, it is determined whether or not the current number of clusters in the top layer is one. If the number is one, the process ends. If the number is more than one, the process returns to step S602, and the process is repeatedly performed until the number of clusters becomes one.

According to the clustering process described above, one cluster in the top layer can be defined from N clusters in the bottom layer, and a tree structure and can be obtained.

In the present embodiment, the center of gravity method is adopted to define the dissimilarity between clusters. Any of other clustering methodologies including the nearest neighbor method, the furthest neighbor method, and the median method may be used to implement the present embodiment. Those methodologies may be modified by the user, as necessary, or a more suitable method obtained from experience may be set in advance. It is to be noted that the center of gravity method employed in the present embodiment is merely an example.

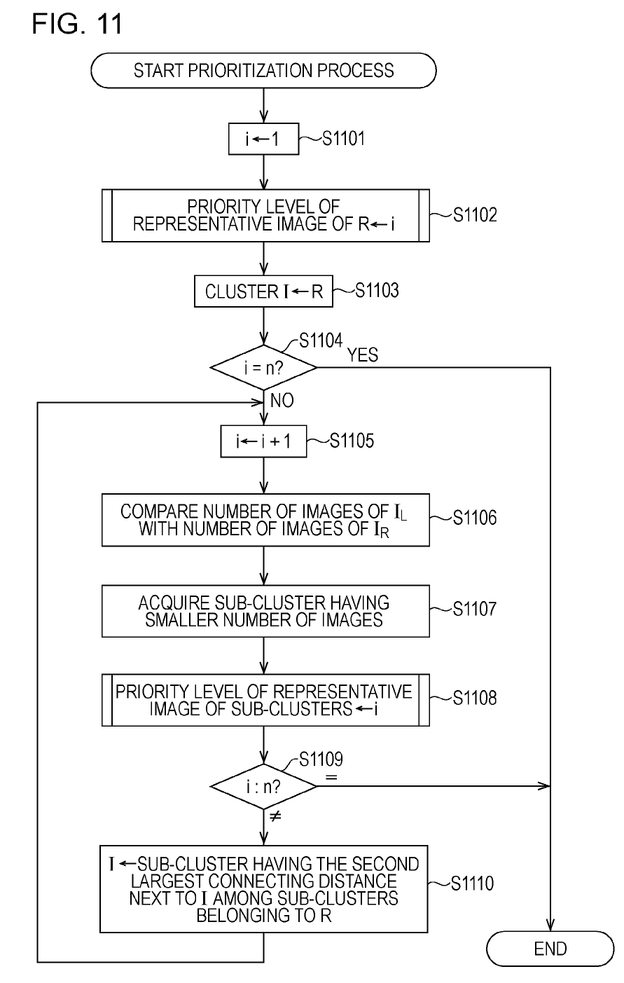

The process for prioritizing the images to be managed, which is performed in step S504 of FIG. 5, on the basis of the tree structure of the N images to be managed, which is obtained by the clustering process in step S503, will be described with reference to a flowchart in FIG. 11.

FIG. 11 is a flowchart illustrating a process for, based on a tree structure obtained for N images to be managed, prioritizing each of the images.

Referring to FIG. 11, in step S1101, an index i indicating a priority level is initialized to “1”.

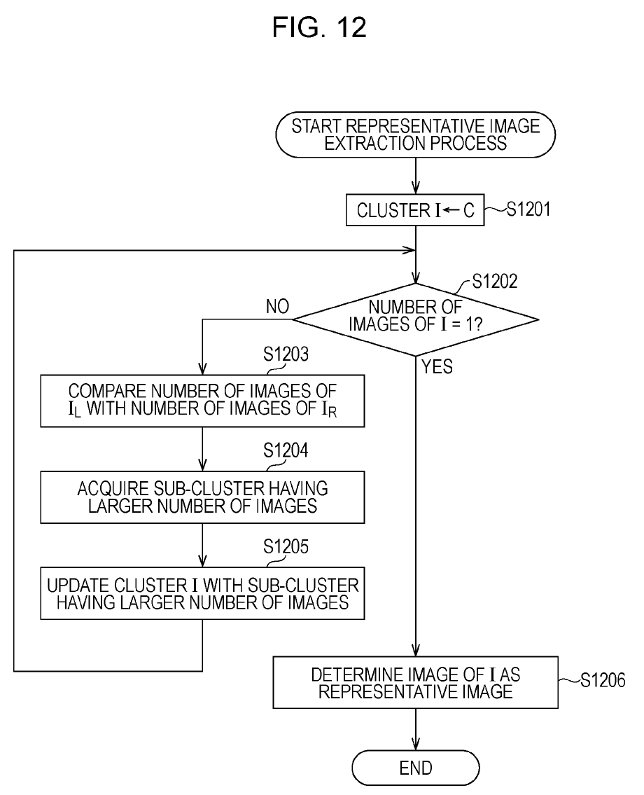

In step S1102, the priority level of an image that is representative of a top level cluster R is set to the value i (=1). A process for extracting a representative image of each cluster will be described below with reference to FIG. 12.

In step S1103, an cluster I is initialized with the cluster R. The following processing is performed on the initialized cluster I.

In step S1104, it is determined whether or not the priority level i is equal to the number n of images to be managed. That is, it is determined whether or not the value n is 1. If the value n is 1, this means that all the images to be managed have been prioritized, and the process ends. If the value n is not 1, the process proceeds to step S1105. In many cases, a large number of images to be managed are handled, and therefore the process proceeds to step S1105.

In step S1105, the index i is incremented.

In step S1106, the numbers of images included in two sub-clusters I_{L} and I_{R} of the cluster I are compared.

In step S1107, if the number of images included in the sub-cluster I_{L} is greater than or equal to the number of images included in the sub-cluster I_{R}, the sub-cluster I_{R} is acquired. If the number of images included in the sub-cluster I_{L} is less than the number of images included in the sub-cluster I_{R}, the sub-cluster I_{L} is acquired.

In step S1108, the priority level i is assigned to the representative image of the sub-cluster acquired in step S1107.

In step S1109, it is determined whether or not the value of the current priority level i has reached the number n of images to be managed. If the value of the priority level i has reached the number n, this means that all the images to be managed have been prioritized, and the process ends. If the value of the priority level i has not reached the number n, the process proceeds to step S1110.

In step S1110, the cluster I is updated with the sub-cluster having the next largest connecting distance among the sub-clusters belonging to the cluster R. The values of connecting distance are values calculated when clusters are merged by the hierarchical clustering process in step S603 of FIG. 6, and are stored in the memory. The process after step S1105 is repeatedly performed on the updated new cluster I until the assigned priority level i has reached the number n.

### Representative Image Extraction Process

Next, a process for extracting a representative image from a given cluster C in steps S1102, S1107, and S1108 will be described with reference to FIG. 12.

FIG. 12 is a flowchart illustrating a process for extracting a representative image from a given cluster C.

Referring to FIG. 12, in step S1201, the cluster I is initialized with the cluster C that is to be subjected to this process.

In step S1202, it is determined whether or not the number of images (the number of cluster elements) included in the cluster I is 1. If the number of images is 1, that is, if the cluster I is present at the bottom of the tree structure, the process proceeds to S1206, in which the image file constituting the bottom cluster is determined as a representative image. Then, the process ends. If the current cluster I is not present at the bottom, the process proceeds to step S1203.

In step S1203, the numbers of images included in sub-clusters I_{L} and I_{R} of the cluster I are compared.

In step S1204, if the number of images included in the sub-cluster I_{L} is greater than or equal to the number of images included in the sub-cluster I_{R}, the sub-cluster I_{L} is acquired. If the number of images included in the sub-cluster I_{L} is less than the number of images included in the sub-cluster I_{R}, the sub-cluster I_{R} is acquired.

In step S1205, the cluster I is updated with the sub-cluster having a larger number of images among the sub-clusters I_{L} and I_{R}, which is acquired in step S1204, and the processing of steps S1202 to S1205 is repeatedly performed until the number of images included in the cluster I becomes 1. In other words, the next-order image is selected from images belonging to the cluster having a large number of images, and the number of images belonging to the cluster is considered as a weight for the prioritization.

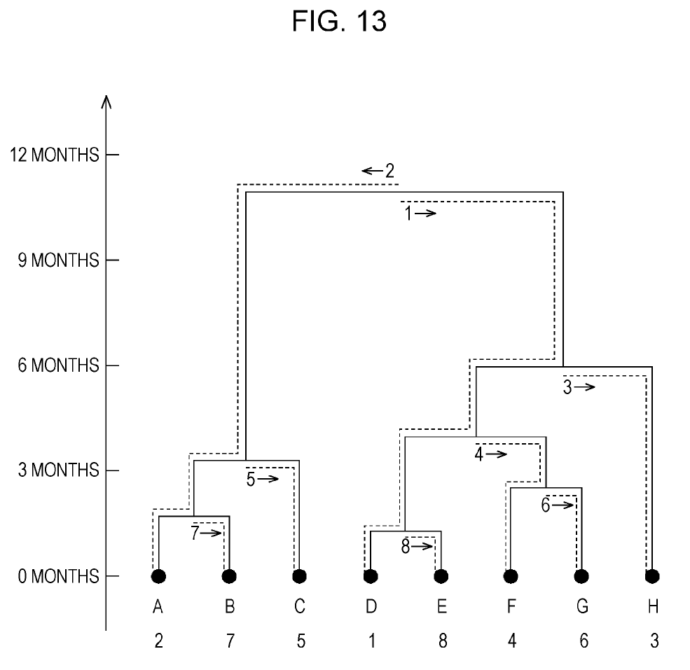

The above described is the prioritization process executed by the image file management program. For example, in FIG. 13, a process for prioritizing the eight images to be managed in the tree structure illustrated in FIG. 10 is illustrated, and the priority levels are determined in the order indicated by arrows.

In the foregoing embodiment, clusters are prioritized so that a cluster having a large number of images and a large connecting distance (having a large difference between shooting dates/times) is assigned a high priority level. Thus, the following features are obtained.

(a) In a cluster including closely related images in terms of shooting date/time, a representative image of that cluster is assigned a high priority level. Images captured around the shooting date/time of the image assigned a high priority are assigned a relatively low priority level. For example, in a case where 20 images are captured for 10 seconds using a digital camera in a continuous shooting mode, it is determined that a set of scenes of those images is important, and one of them is selected and is assigned a high priority level. Since it is expected that the scenes of the remaining 19 images are similar, the 19 images are assigned a low priority level. In this way, the captured images are prioritized. Examples of a case where a large number of images are captured for a short period of time include overseas trips in which, for example, 300 shots are taken a week.

(b) An image that is not closely related in terms of shooting date/time has a large connecting distance from other images, and is assigned a high priority level. Thus, it is determined that, for example, two commemorative photographs of the homecoming party, which were taken one month after an event occurred during which a large number of images were captured for a short period of time, are also important, and are assigned a relatively high priority level.

In the present embodiment, images are classified into groups and are prioritized according to measurements of differences between shooting dates/times thereof. Depending on the combination of images constituting images to be managed, the individual images are dynamically prioritized.

As described above, images to be managed are prioritized in the initialization process of the image file management program. Information regarding the prioritization is referred to, during the execution of the process, each time the thumbnail list view 300 is drawn, in the processes of selecting images to be displayed and determining drawing positions of thumbnails.

### Process for Selecting Images to be Displayed

Next, the process for selecting images to be displayed, which is performed in step S408 of FIG. 4, will be described in detail.

The process for selecting images to be displayed is executed when the number of image files present in the time-axis range set in step S407 of FIG. 4 is greater than the maximum number of displayable images.

The selection of images to be displayed is performed according to the priority levels of the images to be managed, which is determined in FIG. 11. Among image files present in a time-axis range that is set according to those priority levels, image files are selected in descending order from the maximum number of displayable images as the upper limit.

FIG. 14 is a flowchart illustrating a process for selecting images to be displayed.

Referring to FIG. 14, in step S1401, image files present within the time-axis range set in step S407 of FIG. 4 are extracted from among the images to be managed.

In step S1402, the image files extracted in step S1401 are sorted by the priority levels determined in the process illustrated in FIG. 11, and an image list is created.

In step S1403, a number of image files corresponding to the maximum number of displayable images are selected in the image list in order from the image having the highest priority level, and are defined as images to be displayed.

Referring back to FIG. 4, in step S409, positions at which the image files selected in step S1403 are placed on the thumbnail list view 300 are determined according to the priority levels.

### Layout Process on Thumbnail List View

Next, a process for layout of the images to be displayed on the thumbnail list view 300 will be described in detail.

The priority levels assigned in step S504 of FIG. 5, described above, to all the images to be managed are reassigned to the images to be displayed, which are selected in step S408 of FIG. 4, starting from priority level 1, and the reassigned priority levels have a value p.

If an axis perpendicular to the time axis of the rectangular display area is referred to as an importance axis and each image to be displayed is plotted at a pixel position y on the importance axis, the pixel position y is defined by Equation (1) below as a function that depends on the priority level p within the images to be displayed:

y(p)=Y×p/s (1)

where Y denotes the number of pixels in the longitudinal direction of the rectangular display area, and s denotes the number of images to be displayed.

Based on the thus determined importance value and the shooting date/time of each image, a center pixel of the thumbnail of the image is arranged at a coordinate point that is determined in the rectangular display area defined by the time axis and the importance axis. The images are drawn starting from the image having a low priority level. If images overlap each other, an image assigned a higher priority level is drawn above the other. Therefore, the thumbnail list view 300 illustrated in FIG. 3 is produced. In the foregoing description, an image assigned a higher priority level is arranged above others. This method is merely an exemplary layout method. A method with increased ease of use may be employed. For example, once a pointer is placed on an image using a mouse, the manner of overlap may be changed correspondingly.

According to the importance value given in Equation (1), if images are assigned priority levels that are close to each other, the importance values of the images are also close to each other. Conversely, if the difference between priority levels assigned to images is large, the difference between importance values of the images is also large and the images are drawn at distant positions on the importance axis. Due to the feature of prioritization that, as described above, priority levels have a discrete value with respect to the distribution of shooting dates/times, resulting importance values are spaced apart from each other if shooting dates/times are relatively close to each other within a display area. That is, images that are close in the direction of the time axis have a tendency of being spaced far apart in the direction of the importance axis. Thus, the area where images to be displayed overlap one another on the screen is generally small. Accordingly, the layout method of the present embodiment provides easy-to-view display of images used as search keys, which are of importance to the user, and a high-visibility layout with a large amount of information provided on one screen can be implemented with an amount of calculation that can be performed in real time.

In the example described above, thumbnails are arranged on the basis of the center pixels thereof. It is to be appreciated that thumbnails may be instead arranged on the basis of pixels other than the center pixels thereof, such as the lower left corner pixels thereof, to achieve the essence of the invention. In Equation (1), which is used to determine a position on the importance axis, an image assigned a higher priority level is closer to the origin on the importance axis. If the origin of the importance axis is set at the upper end of the rectangular display area, an image assigned a higher priority level among images to be displayed is closer to the upper end of the screen. Assuming that the human eye tends to focus more on the center of the screen, a layout in which such an image is close to the center rather than the end of the screen may be more preferable. For instance, if the origin of the importance axis is set as the center of the rectangular display area and the importance value is defined by Equations (2) and (3) below, an image assigned a higher priority level is closer to the center of the screen:

y(p)=Y×p/2s, where p is an even number (2)

y(p)=−Y×p/2s, where p is an odd number (3)

However, it does not matter, for the essence of the invention, where the origin of the importance axis is located. In an embodiment of the present invention, any definition may be used as far as the pixel positions y behave in a continuous manner with respect to the priority level p.

According to the present embodiment, therefore, an image used as a search key, which is of importance to the user, can be displayed with priority, and a high-visibility layout can be obtained even if there are a large number of image files.

### Other Embodiments

The present invention may also encompass a computer program for achieving the functions of the foregoing embodiment by directly or remotely supplying the computer program to a system or an apparatus. In this case, a computer of the system or the like can read and execute the computer program.

Thus, a computer program which is installed in a computer to achieve the functional processing of the present invention by using the computer also constitutes an embodiment of the present invention.

In this embodiment, the computer program may be in the form of object code, program code executable by an interpreter, or script data to be supplied to an OS as long as it has a function of a program.

Examples of recording media (storage media) supplying a program include a flexible disk, a hard disk, an optical disk, and a magneto-optical (MO) disk. The examples of the recording media (storage media) further include a compact disc read only memory (CD-ROM), a CD-Recordable (CD-R), a CD-Rewritable (CD-RW), a magnetic tape, a non-volatile memory card, a ROM, and a digital versatile disk (DVD) (e.g., a DVD-ROM and DVD-R).

Another program supply method may be to access a homepage on the Internet using a browser of a client computer so that a computer program of the present invention can be downloaded from the homepage. Alternatively, the program may be supplied by downloading a compressed file including an automatic installation function into a recording medium such as a hard disk. Alternatively, a computer program constituting a program of the present invention may be divided into a plurality of files and each of the files may be downloaded from different homepages. A World Wide Web (WWW) server that allows a plurality of users to download a program file for implementing the functional processing of the present invention using a computer may also fall within the scope of the present invention.

Alternatively, a program of the present invention may be distributed to users in such a manner that the program is encrypted and stored in a storage medium such as a CD-ROM, and a user meeting predetermined conditions may download decryption key information from a homepage via the Internet. In this case, the downloaded key information is used to execute the encrypted program to install the program in a computer, thereby achieving the functional processing of the present invention.

Alternatively, a computer may execute a read program to implement the functions of the foregoing embodiment, or an OS or the like running on a computer may execute part of or the entirety of actual processing according to the instruction of the program to implement the functions of the foregoing embodiment.

Furthermore, a program read from a recording medium is written in a memory of a function extension board placed in a computer or a function extension unit connected to the computer, and thereafter a CPU of the board or the like may execute part of or the entirety of actual processing to implement the functions of the foregoing embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-233383, filed Sep. 7, 2007, which is hereby incorporated by reference herein in its entirety.

What is claimed is:

1. An image management apparatus that manages a plurality of images, the image management apparatus comprising:
an assigning unit configured to assign priority levels to the images; and
a drawing unit configured to draw the images in a display area having a time axis according to a layout that is based on the assigned priority levels and pieces of time information of the images,
wherein the assigning unit assigns priority levels to the images so that a difference between a piece of time information of an n-th priority level image and a piece of time information of an (n+1)-th priority level image is greater than a difference between the piece of time information of the n-th priority level image and a piece of time information of an (n+2)-th priority level image.

2. The apparatus according to claim 1, further comprising a classifying unit configured to classify the plurality of images into groups on the basis of the differences between the pieces of time information of the images,
wherein the assigning unit assigns priority levels to the images further on the basis of the number of images belonging to each of the groups.

3. The apparatus according to claim 1, further comprising an image selecting unit configured to select images to be drawn in the display area among the plurality of images in order from an image assigned a high priority level.

4. The apparatus according to claim 1, further comprising a drawing position determining unit configured to determine positions at which the images are to be drawn along the time axis according to the pieces of time information and to determine positions at which the images are to be drawn in a direction perpendicular to the time axis according to the assigned priority levels.

5. The apparatus according to claim 1, further comprising a time axis setting unit configured to set a range on the time axis of the display area,
wherein the drawing unit draws images having pieces of time information whose values are within the set range on the time axis.

6. An image management apparatus that manages a plurality of images, the image management apparatus comprising:
an assigning unit configured to assign priority levels to the plurality of images; and
a drawing unit configured to draw the images in a display area having a time axis according to a layout that is based on the assigned priority levels and pieces of time information of the images,
wherein the assigning unit classifies the images into hierarchical groups on the basis of differences between the pieces of time information of the images, and assigns priority levels to the images on the basis of the number of images belonging to each of the groups and measurements among the differences between the pieces of time information within the individual groups.

7. The apparatus according to claim 6, further comprising an image selecting unit configured to select images to be drawn in the display area among the plurality of images in order from an image assigned a high priority level.

8. The apparatus according to claim 6, further comprising a drawing position determining unit configured to determine positions at which the images are to be drawn along the time axis according to the pieces of time information and to determine positions at which the images are to be drawn in a direction perpendicular to the time axis according to the assigned priority levels.

9. The apparatus according to claim 6, further comprising a time axis setting unit configured to set a range on the time axis of the display area,
wherein the drawing unit draws images having pieces of time information whose values are within the set range on the time axis.

10. A control method for an image management apparatus that manages a plurality of images, the control method comprising:
assigning priority levels to the images; and
drawing the images in a display area having a time axis according to a layout that is based on the assigned priority levels and pieces of time information of the images,
wherein in the assigning, priority levels are assigned to the images so that a difference between a piece of time information of an n-th priority level image and a piece of time information of an (n+1)-th priority level image is greater than a difference between the piece of time information of the n-th priority level image and a piece of time information of an (n+2)-th priority level image.

11. A control method for an image management apparatus that manages a plurality of images, the control method comprising:
assigning priority levels to the plurality of images; and
drawing the images within a display area having a time axis according to a layout that is based on the assigned priority levels and pieces of time information of the images,
wherein in the assigning, the images are classified into hierarchical groups on the basis of differences between the pieces of time information of the images, and priority levels are assigned to the images on the basis of the number of images belonging to each of the groups and measurements among the differences between the pieces of time information within the individual groups.

12. A computer-readable storage medium on which is stored a computer program for causing a computer to implement an image management apparatus that manages a plurality of images, and execute a method of controlling, the program comprising:
assigning priority levels to the images; and
drawing the images in a display area having a time axis according to a layout that is based on the assigned priority levels and pieces of time information of the images,
wherein in the assigning, priority levels are assigned to the images so that a difference between a piece of time information of an n-th priority level image and a piece of time information of an (n+1)-th priority level image is greater than a difference between the piece of time information of the n-th priority level image and a piece of time information of an (n+2)-th priority level image.

13. A computer-readable storage medium on which is stored a computer program for causing a computer to implement an image management apparatus that manages a plurality of images, and execute a method of controlling, the program comprising:
assigning priority levels to the plurality of images; and
drawing the images within a display area having a time axis according to a layout that is based on the assigned priority levels and pieces of time information of the images,
wherein in the assigning, the images are classified into hierarchical groups on the basis of differences between the pieces of time information of the images, and priority levels are assigned to the images on the basis of the number of images belonging to each of the groups and measurements among the differences between the pieces of time information within the individual groups.
